(19) United States
(12) Patent Application Publication
(10) Pub. No.: US 2026/0281313 A1
(43) Pub. Date: Sep. 17, 2026

(54) METHODS AND APPARATUS OF REORDERING CANDIDATES FOR EXTRAPOLATION INTRA PREDICTION MODEL INHERITANCE IN VIDEO CODING

(71) Applicant: MEDIATEK INC., Hsinchu City (TW)

(72) Inventors: Hsin-Yi TSENG, Hsinchu City (TW); Cheng-Yen CHUANG, Hsinchu City (TW); Yi-Wen CHEN, San Jose, CA (US); Tzu-Der CHUANG, Hsinchu City (TW); Ching-Yeh CHEN, Hsinchu City (TW); Chih-Wei HSU, Hsinchu City (TW); Yu-Wen HUANG, Hsinchu City (TW)

(21) Appl. No.: 19/473,441

(22) PCT Filed: Oct. 12, 2024
(86) PCT No.: PCT/CN2024/124338

§ 371 Date: Oct. 7, 2025

Related U.S. Application Data
(60) Provisional application No. 63/589,654, filed on Oct. 12, 2023.

(51) Int. Cl. H04N 19/105; H04N 19/176; H04N 19/88

(52) U.S. Cl. CPC H04N 19/105; H04N 19/176; H04N 19/88

(57) ABSTRACT

A method and apparatus for video coding using Extrapolation Intra Prediction (EIP) mode related modes are disclosed. According to this method, an EIP candidate list comprising one or more EIP candidates is derived. The EIP candidates in the EIP candidate list are reordered according to model errors, wherein computation of the model errors comprises deriving prediction samples of a neighbouring template by applying one or more candidate models associated with said one or more EIP candidates to the neighbouring template of the current block, and comparing differences between reconstruction samples and the predictions samples of the neighbouring template, and wherein said deriving prediction samples of the neighbouring template, said comparing differences, or both are performed by using simplified computation. The current block is encoded or decoded by using information comprising the EIP candidate list.

### CROSS REFERENCE TO RELATED APPLICATIONS

The present invention is a non-Provisional Application of and claims priority to U.S. Provisional Patent Application No. 63/589,654, filed on Oct. 12, 2023. The U.S. Provisional Patent Application is hereby incorporated by reference in its entirety.

### FIELD OF THE INVENTION

The present invention relates to video coding system using Extrapolation Intra Prediction (EIP) mode. In particular, the present invention relates to improving EIP performance by reordering EIP candidate list according to model errors.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work. The reference software can be accessed via https://vcgit.hhi.fraunhofer.de/ecm/ECM.git. ECM basically is the successor to VVC and thus it shares many common parts as VVC.

In the present invention, methods and apparatus to improve performance for video coding systems using EIP the mode are disclosed.

### BRIEF SUMMARY OF THE INVENTION

A method and apparatus for video coding using Extrapolation Intra Prediction (EIP) mode related modes are disclosed. According to this method, input data associated with a current block is received, wherein the input data comprises pixel data to be encoded at an encoder side or data associated with the current block to be decoded at a decoder side. An EIP (Extrapolated Intra Prediction) candidate list is derived, wherein the EIP candidate list comprises one or more EIP candidates. Said one or more EIP candidates in the EIP candidate list are reordered according to model errors, wherein computation of the model errors comprises deriving prediction samples of a neighbouring template by applying one or more candidate models associated with said one or more EIP candidates to the neighbouring template of the current block, and comparing differences between reconstruction samples and the predictions samples of the neighbouring template, and wherein said deriving prediction samples of the neighbouring template, said comparing differences, or both are performed by using simplified computation. The current block is encoded or decoded by using information comprising the EIP candidate list, wherein if a target EIP candidate is selected, an EIP predictor of the current block is generated based on the target EIP candidate.

In one embodiment, the model errors are calculated by using partial positions inside the neighbouring template. In one embodiment, the partial positions correspond to subsampled positions of the neighbouring template.

In one embodiment, the neighbouring template comprises an above neighbouring temple on an above side of the current block, and a start position and a subsampling interval of the subsampled positions of the above neighbouring template depend on width of the current block. In one embodiment, the neighbouring template comprises a left neighbouring temple on a left side of the current block, and a start position and a subsampling interval of the subsampled positions of the left neighbouring template depend on height of the current block.

In one embodiment, the model errors are calculated by using an above neighbouring temple on an above side of the current block, and height of the above neighbouring template corresponds to a constant or depends on current block size. In one embodiment, the model errors are calculated by using a left neighbouring temple on a left side of the current block, and width of the left neighbouring template corresponds to a constant or depends on current block size.

In one embodiment, the model errors are calculated by applying partial model parameters of said one or more EIP candidates to the neighbouring template of the current block respectively. In one embodiment, unchosen parameters of model parameters are set to 0 while chosen parameters of the partial model parameters are kept the same.

In one embodiment, the model errors are calculated by applying precision-reduced model parameters of said one or more EIP candidates to the neighbouring template of the current block respectively. In one embodiment, bit-depth of model parameters of said one or more EIP candidates are reduced before said applying the precision-reduced model parameters of said one or more EIP candidates to the neighbouring template of the current block respectively. In one embodiment, the bit-depth of model parameters of said one or more EIP candidates are reduced using clipping operations, pruning operation, or rounding operation. In one embodiment, if a target model parameter is smaller than a pruning threshold, the target model parameter is set to zero.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIGS. 2A-C illustrate three types (FIG. 2A: Left-Top area, FIG. 2B: Top area, and FIG. 2C: Left area) of reconstructed areas used to derive filter coefficients for EIP.

FIG. 3 illustrates three types of filter shapes with fifteen inputs and generate one output for EIP process.

FIG. 4 illustrate an example of scanning order for generating predictions for different positions in the current block by a diagonal order.

FIG. 5 illustrates examples of square EIP filters.

FIG. 6 illustrates examples of horizontal-shaped EIP filters.

FIG. 7 illustrates examples of vertical-shaped EIP filters.

FIG. 8 illustrates examples of diamond-shaped EIP filters.

FIG. 9 illustrates examples for the target sample located at the next row or column of the kernel block of the multiple-source sample-based prediction.

FIG. 10 illustrates examples where the multiple-source sample-based prediction is only applied to the boundary samples of the current block.

FIG. 11 illustrates an example where the multiple-source sample-based predictors are combined with the other intra mode predictors.

FIG. 12 illustrates an example of positions of spatial merge candidate.

FIG. 13 illustrates an example of spatial neighbouring blocks used to derive the spatial merge candidates.

FIG. 14 illustrates an example of the neighbouring templates for calculating the model error.

FIG. 15 illustrates a flowchart of an exemplary video coding system that reorders EIP candidates in an EIP candidate list based on model errors associated with the reorders EIP candidates according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### The Extrapolation Intra Prediction (EIP):

In JVET-AD0081, a method “extrapolation intra prediction” is proposed. The proposed extrapolation filter-based intra prediction, according to JVET-AD0081, is processed in three steps. First, the min, max and offset values are obtained from a pre-defined reconstructed area. Second, the extrapolation filter coefficients are obtained from the neighbouring reconstructed pixels of the current block's pre-determined template (i.e., the pre-defined reconstructed are in the first step). Third, the extrapolation process generates a predicted value position by position from the top-left to bottom-right corner within the current block. According to AD0081, the application of EIP is restricted to the block size not greater than 32×32 and intra slice only. Since the proposed EIP process (proposed in AD0081) generates the predictor for each sample in one block (i.e., the process generates the predictor position-by-position in one block), this process is given an alternative name as “multiple source sample-based prediction” in this current disclosure.

### Obtaining the Min, Max, and Offset Value for EIP

Similar to CCCM (Convolutional Cross-Component Model) mode, an offset value is removed when feeding the inputs to the EIP filter. The top-left reconstructed pixel from a pre-defined neighbouring area of the current block is used as the offset value for EIP prediction. The min and max values are obtained from reconstructed pixels in the pre-defined reconstructed area of the current block.

### Calculation of Filter Coefficients for EIP

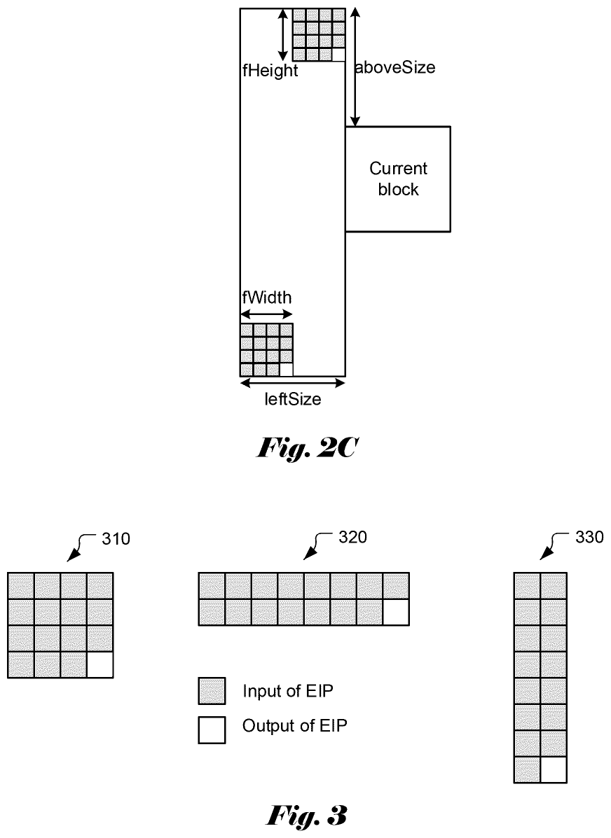

Three types of reconstructed areas and three filter shapes are proposed as shown in FIG. 2 and FIG. 3 respectively. In FIG. 2, the three reconstructed areas correspond to Left-Top area (FIG. 2A), Top area (FIG. 2B), and Left area (FIG. 2C). The size of reconstructed area depends on the min (blockWidth, blockHeight) and the selected filter shape. For example, when the current block is an 8×16 block and the selected filter shape is 4×4. The aboveSize of reconstructed area is min (8, 16)+4−1=11, and the leftSize of reconstructed area is min (8, 16)+4−1=11. In FIG. 3, the three filter shapes correspond to square 310, horizontal strip 320, and vertical strip 330. The selected filter moves in the selected reconstructed area with a one-pixel step to collect input samples and output samples of EIP. The auto-correlation matrix and cross-correlation vector are constructed while removing the offset value from input samples and output samples. Then, the EIP coefficients are obtained by the same method in CCCM.

### Prediction of Current Block for EIP

The EIP mode generates predictions for the current block from the top-left position to the bottom-right position by a diagonal prediction order, as shown in FIG. 4, where the arrows indicate the moving direction of the 4×4 filter.

To reduce the prediction error, the min and max values from the neighbouring reconstructed area are applied to restrict the output range of each predicted value.

The calculation for predicted samples in the test is shown as follows,

$${pred}_{( x , y )} = clip ( min , max , {\sum }_{i = 0}^{14} ( {c}_{i} \times ( {t}_{( x - xoffset , y - yoffset )} - offset ) ) + offset )$$

where pred_{(x,y)} is the predicted value at (x, y) in the current block. min, max and offset are the values described above. cᵢ is the i^{th} coefficient of the derived EIP filter, the index of the coefficients is from 0 to 14, t_{(x-xoffset,y-yoffset)} is reconstructed or predicted value used for the current position's prediction.

### Cross-Component Prediction (CCP) Merge (a.k.a., Non-Local CCP) Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. A CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, 1/8, −1/8, 2/8, −2/8, 3/8, −3/8, 4/8, −4/8, 5/8, −5/8, 6/8}. Otherwise, the default scaling parameters are {0, the scaling parameter of the first CCLM candidate+ {1/8, −1/8, 2/8, −2/8, 3/8, −3/8, 4/8, −4/8, 5/8, −5/8, 6/8}}. The offset parameter is derived according to the default scaling parameter, average neighbouring reconstructed luma sample value, and average neighbouring reconstructed Cb/Cr sample value.

A flag is signalled to indicate whether the CCP merge mode is applied or not. If CCP merge mode is applied, an index is signalled to indicate which candidate model is used by the current block. In addition, CCP merge mode is not allowed for the current chroma coding block when the current CU is coded by Intra Sub-Partitions (ISP) with single tree, or the current chroma coding block size is less than or equal to 16.

In order to improve video coding systems using EIP mode, methods and apparatus to efficiently code a selected candidate from the EIP candidate list are disclosed.

### I. Extension of EIP

In the first embodiment, various patterns of sources (i.e., various filter shape) are defined for the multiple source sample-based prediction as illustrated below. The proposed prediction scheme can be applied to luma component, chroma component or both. It is noted that each source sample (i.e., the input to the filter) can be a reconstructed sample, or a predictor sample generated by the multiple source sample-based prediction. When neither the reconstructed sample nor the predictor sample is available for that source sample, a default sample can be used. The default sample can be a pre-defined value such as the middle value within the full range of the sample value. The default sample can also be the predictor generated by the existing intra prediction method such as TIMD, DIMD, CCLM, CCCM, Planar mode, DC mode, Angular intra prediction modes, MIP and so on.

### Type 1 (Square Shape):

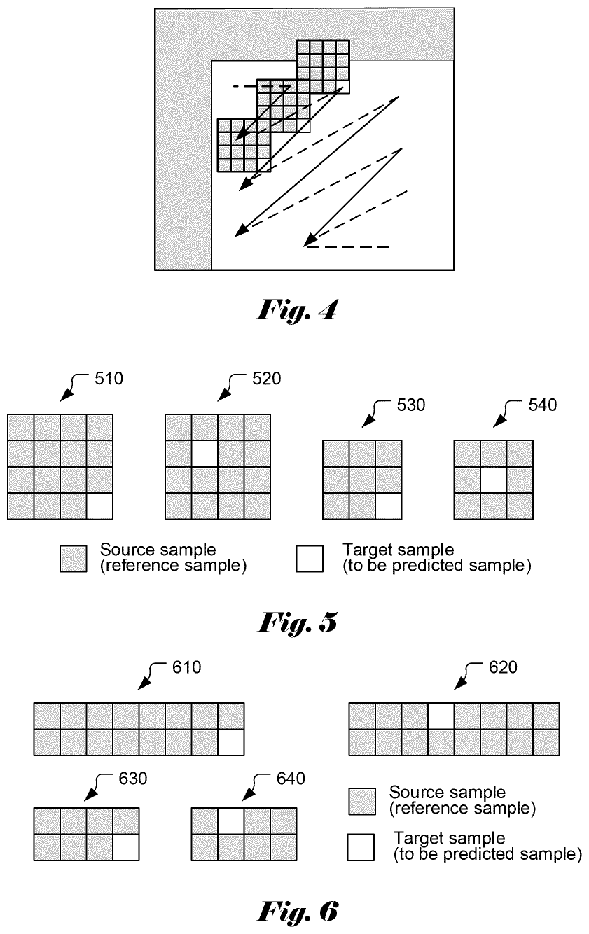

As shown in the FIG. 5, N×N−1 source samples are used to generate the predictor for the target (to be predicted) sample. The target sample can be any sample within the N×N block. In FIG. 5, two 4×4 patterns (510 and 520) and two 3×3 patterns (3×3) are shown.

### Type 2 (Horizontal Shape):

As shown in the FIG. 6, M×N−1 (M>N) source samples are used to generate the predictor for the target (to be predicted) sample. The target sample can be any sample within the M×N block. In FIG. 6, two 8×2 patterns (610 and 620) and two 4×2 patterns (630 and 640) are shown.

### Type 3 (Vertical Shape):

As shown in the FIG. 7, M×N−1 (M<N) source samples are used to generate the predictor for the target (to be predicted) sample. The target sample can be any sample within the M×N block. In FIG. 7, two 2×8 patterns (710 and 720) and two 2×4 patterns (730 and 740) are shown.

### Type 4 (Diamond Shape):

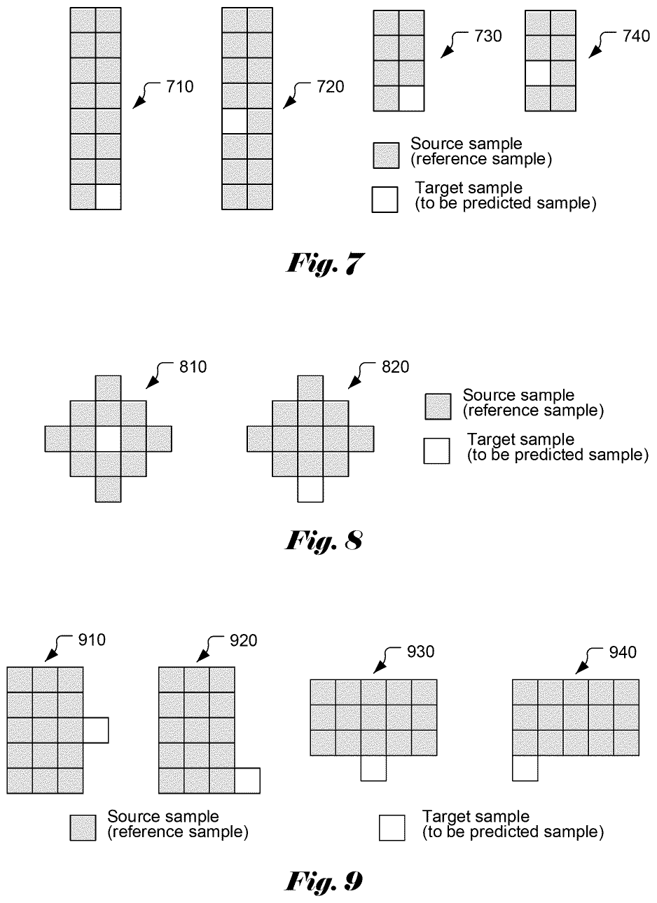

As shown in the FIG. 8, an M-tap diamond shape kernel is used in multiple-source sample-based prediction. M−1 source samples are used to generate the predictor for the target (to be predicted) sample. The target sample can be any sample within the M-tap diamond shape kernel. In FIG. 8, two 5×5 patterns (810 and 820) are shown. The terms “kernel” and “filter shape” are used interchangeably in this disclosure.

In the second embodiment, the target sample can be located at the next row or column of the kernel block of the multiple-source sample-based prediction as shown in FIG. 9. If the target sample is located at the next row of the kernel block (configurations 930 and 940 in FIG. 9), there are no dependencies between predictions in the same row, so the predictor can be generated in parallel in the horizontal direction. If the target sample is located at the next column of the kernel block (configurations 910 and 920 in FIG. 9), there is no dependency between predictions in the same column, so the predictor can be generated in parallel in the vertical direction.

In the third embodiment, in addition to the source samples, non-linear term of source samples can also be part of the input data of the multiple-source sample-based prediction. The non-linear term is defined as the square of the samples.

The bias term can also be part of the input data of the multiple-source sample-based prediction.

The horizontal and/or vertical location term can also be part of the input data of the multiple-source sample-based prediction. The location term can be the horizontal or vertical coordinate of the target sample with the origin at a pre-defined position. For example, the origin can be the upper left position of the picture, slice, CTU or current block.

The predictor from other existed intra prediction method such as TIMD, DIMD, CCLM, CCCM, Planar mode, DC mode, Angular intra prediction modes, MIP and so on can also be part of the input data of the multiple-source sample-based prediction.

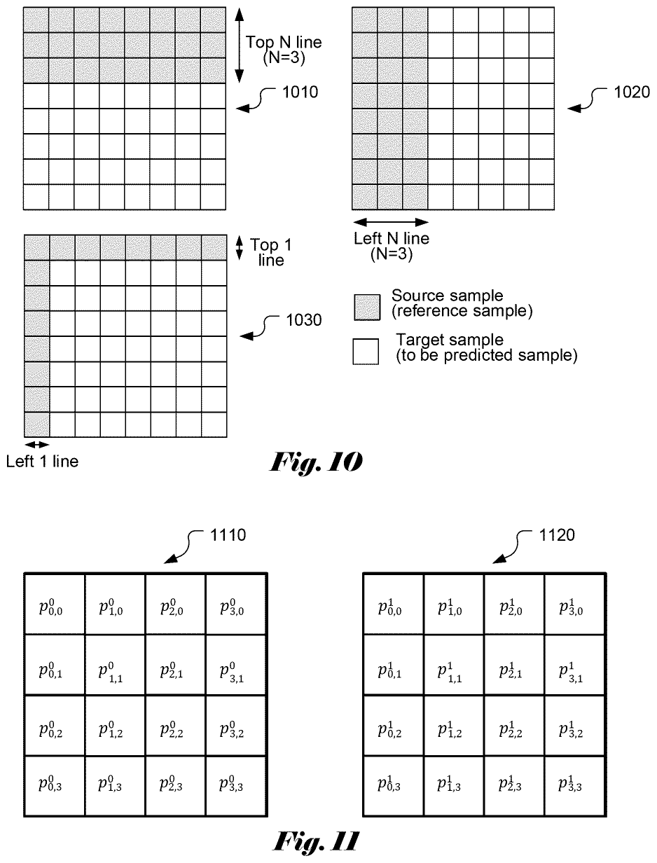

In the fourth embodiment, the multiple-source sample-based prediction is only applied to the boundary samples of the current block. That is, only the boundary samples are predicted using EIP. The boundary samples are defined as the top N lines samples and/or left N lines samples as illustrated in FIG. 10, where each square represents one sample. In FIG. 10, configurations corresponding to top 3 lines (1010), left 3 lines (1020) and 1 top line and 1 left line (1030) as the target samples (output of EIP filter).

In the fifth embodiment, the multiple-source sample-based predictors are combined with the other intra mode predictors including but not limited to the existed intra prediction modes such as the TIMD, DIMD, CCLM, CCCM, Planar, DC, Angular prediction modes, MIP and so on.

As illustrated in FIG. 11,

$${p}_{i , j}^{0}$$

(1110) is the predictor for the sample located at the position (i, j) generated by the multiple-source sample-based prediction.

$${p}_{i , j}^{1}$$

(1120) is the predictor for the sample located at the position (i, j) generated by the existing intra prediction mode. The final predictor for the sample located at the position (i, j) can be generated by a linear combination of

$${p}_{i , j}^{0} and {p}_{i , j}^{1}$$

with a set of weight (w₀, w₁). These weights can be pre-defined values or values selected from a set of pre-defined weights. The weights can also be derived by a regression-based method which using neighbouring samples for training.

In the sixth embodiment, the multiple-source sample-based predictors can be applied with source samples being the reconstructed samples or the predictor samples generated by the existing intra prediction modes such as the TIMD, DIMD, CCLM, CCCM, Planar, DC, angular prediction modes, MIP and so on.

In the seventh embodiment, multi-model design like MMLM mode can be applied to multiple-source sample-based prediction.

The model selection can depend on a threshold which is the average of neighbouring reconstructed samples.

If the source sample of multiple-source sample-based predictor is the predictor sample generated by the existing intra prediction, the model selection can depend on the comparing result between the multi-model threshold and the source sample at the position of target sample.

If the source sample of multiple-source sample-based predictor is reconstructed sample or a predictor sample generated by the multiple source sample-based prediction, there is no available sample at the position of target sample, so the model selection can depend on the comparing result between the multi-model threshold and a predicted source sample at the position of target sample. The predicted source sample at the position of target sample can be one of the source samples in the kernel. Or the predicted source sample at the position of target sample can be derived by its neighbouring source samples. For example, the predicted source sample can be the average of its above source sample and its left source sample, or it can be the average of all source samples in the kernel.

The model selection can also depend on the position of the target sample. For example, if the horizontal position of the target sample relative to the top-left corner of the current block is larger than the vertical position of the target sample relative to the top-left corner of the current block, the first model is used. Otherwise, the second model is used.

### II. EIP Model Inheritance

II.1 Inheriting EIP information

In one embodiment, all or part of the EIP information of (associated with) an inherited EIP model can be stored together with the inherited EIP model parameters. All or part of the EIP information associated with an EIP model can be stored together with the EIP model parameters. The EIP information and the EIP model parameters are stored associated with a block. EIP model parameters refer to EIP filter coefficients as described in the sections entitled as “Calculation of filter coefficients for EIP” and “Prediction of Current Block for EIP”.

The EIP information includes, but not limited to, template region selection type (e.g., EIP_T, EIP_L or EIP_LT), size of template region, kernel type (e.g., 4×4 square kernel, 8×2 rectangular kernel or 2×8 rectangular kernel), multi-model flag, classification method for multi-model, threshold for multi-model, fusion flag, fusion method, post-filtering flag or model parameters. The template region refers to the reconstructed are of EIP. EIP_T, EIP_L and EIP_LT refer to the Top area (FIG. 2B), Left area (FIG. 2C), and Left-Top area (FIG. 2A) respectively. The kernel type refers to the filter shape type.

### II.2 Inheriting Spatial Neighbouring Model Parameters

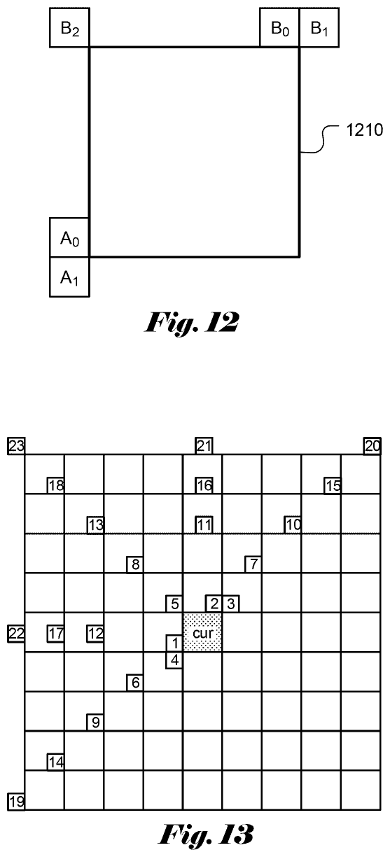

In one embodiment, the inherited model parameters can be from a block that is an immediate neighbouring block. The models from blocks at pre-defined positions are added into the candidate list in a pre-defined order. For example, the pre-defined positions can be the positions as illustrated in the FIG. 12 for the current block 1210, and the pre-defined order can be B₀, A₀, B₁, A₁ and B₂, or A₀, B₀, B₁, A₁ and B₂.

### II.3 Inheriting Temporal Neighbouring Model Parameters

In one embodiment, if the current slice/picture is a non-intra slice/picture, the inherited model parameters can be from the block in the previous coded slices/pictures. In one embodiment, the current block position is at (x, y) and the block size is w×h. The two value sets ax and ay are defined as:

$${α}_{x} = \{ {α}_{x 1} , {α}_{x 2} , {α}_{x 3} , ... , {α}_{xn} \} , {α}_{xi} < {α}_{xj} if i < j$$

$${α}_{y} = \{ {α}_{y 1} , {α}_{y 2} , {α}_{y 3} , ... , {α}_{yn} \} , {α}_{yi} < {α}_{yj} if i < j$$

All values in ax and ay are positive numbers. Let (x_{mid}, y_{mid})=(x+w/2, y+h/2). The inherited model parameters can be from the block at positions (x_{mid}+αₓᵢ×w, y_{mid}+α_{yi}×h), (x_{mid}+αₓᵢ×w, y_{mid}−α_{yi}×h), (x_{mid}−αₓᵢ×w, y_{mid}+α_{yi}×h), (x_{mid}−αₓᵢ×w, y_{mid}−α_{yi}×h), (x_{mid}+αₓᵢ×w, 0), (x_{mid}−αₓᵢ×w, 0), (0, y_{mid}+α_{yi}×h), (0, y_{mid}−α_{yi}×h), (x_{mid}+αₓᵢ×w, y_{mid}), (x_{mid}−αₓᵢ×w, y_{mid}), (x_{mid}, y_{mid}+α_{yi}×h), (x_{mid}, y_{mid}−α_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, αₓ={1/2, 1, 3/2, 2, 5/2} and α_{y}={1, 2, 3, 4, 5}.

In another embodiment, the current block position is at (x, y) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, 0), (x−αₓᵢ×w, 0), (0, y+α_{yi}×h), (0, y−α_{yi}×h), (x+αₓᵢ×w, y), (x−αₓᵢ×w, y), (x, y+α_{yi}×h), (x, y−d_{yi}×h) of the previous coded slices/picture.

In one sub-embodiment, αₓ=α_{y}. For example, αₓ=α_{y}={1, 2, 3, 4, 5}.

In another sub-embodiment, αₓ≠α_{y}. For example, αₓ={1/2, 1, 3/2, 2, 5/2} and α_{y}={1, 2, 3, 4, 5}.

In another embodiment, the current block position is at (x, y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at (x, y), (x+w−1, y), (x, y+h−1), (x+w−1, y+h−1), (x+w/2, y+h/2). For another example, the positions are outside of the corresponding area of the current encoding block, i.e., x′<x+ or x′≥x+w, and/or y′<y or y′≥y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1, y+h), (x+w, y+h−1), (x+w−1, y+h), (x+w, y+h).

In one embodiment, the previous coded picture which the inherited parameter model is from, i.e., the collocated picture, is one of the pictures in the reference lists. The previous coded picture which the inherited parameter is from is called the collocated picture hereafter.

In one embodiment, the collocated picture is the same as the collocated reference picture of TMVP of inter merge mode. In another embodiment, the collocated picture can be different from the collocated reference picture of TMVP of inter merge mode.

In one embodiment, the collocated picture is signalled in the picture/slice header. The reference list and the reference index are signalled in the picture/slice header. For example, the collocated picture is selected as L0[0]. For another example, the collocated picture is selected as L1[0].

In one embodiment, the collocated picture is selected as the picture in the reference lists whose POC difference between the picture and the current picture is the smallest.

In another embodiment, the picture with the smaller POC is selected as collocated picture.

In another embodiment, the picture with the larger POC is selected as collocated picture.

In another embodiment, the picture with smaller QP difference between the picture and the current picture is selected as collocated picture.

In still another embodiment, the picture with the smaller QP is selected as the collocated picture.

In still another embodiment, the picture with the larger QP is selected as the collocated picture.

In one embodiment, the collocated picture is selected as the picture in the reference lists whose QP difference between the picture and the current picture is the smallest.

In one embodiment, the rules to determine the collocate picture described in some embodiments can be combined.

In one embodiment, the previous coded picture the inherited parameter model is from, i.e., the collocated picture, is the most recently coded I-picture. The EIP model information of the most recently coded I-slice/picture is stored in a long-term reference buffer.

### II.4 Inheriting Non-Adjacent Spatial Neighbouring Models

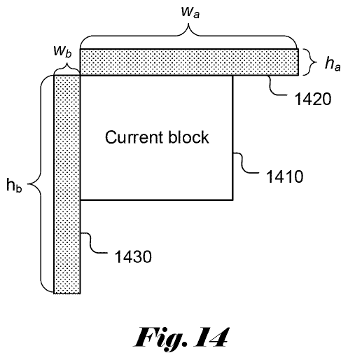

In one embodiment, the inherited model parameters can be from blocks that are spatial neighbouring blocks. The models from blocks at pre-defined positions are added into the candidate list in a pre-defined order. For example, the pattern of the positions and order can be as the pattern depicted in FIG. 13, where the distance between each position is based on the width and height of the current coding block. For another embodiment, the distance between the positions that are closer to the current encoding block is smaller than the positions that are further away from the current block. For another embodiment, the distance between the positions that are closer to the current encoding block is larger than the positions that are further away from the current block.

II.5 Inheriting Model Parameters from History Table

In one embodiment, the inherited model parameters can be from a EIP model history table. The models in the history table can be added into the candidate list according to a pre-defined order. In one embodiment, the adding order of historical candidate can be from the beginning of the table to the end of the table. In another embodiment, the adding order of historical candidate can be from a certain pre-defined position to the end of the table. In another embodiment, the adding order of historical candidate can be from the end of the table to the beginning of the table. In another embodiment, the adding order of historical candidate can be from a certain pre-defined position to the beginning of the table. In another embodiment, the adding order of historical candidate can be in an interleaved manner (e.g., the first added candidate is from the beginning of the table, the second added candidate is from the end of the table and so on).

In one embodiment, single EIP model history table can be maintained for storing the previous EIP model, and the history table can be reset at the start of the current picture, current slice, current tile, every M CTU rows or every N CTUs, N and M can be any value greater than 0. In another embodiment, the EIP model history table can be reset at the end of the current picture, current slice, current tile, current CTU row or current CTU.

### II.6 Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the candidate list can include spatial neighbouring candidates, temporal neighbouring candidate, historical candidates, non-adjacent neighbouring candidates.

In another embodiment, if all the pre-defined neighbouring and historical candidates are added, but the maximum candidate number is not reached, some default candidates are added into the candidate list until the maximum candidate number is reached.

In another embodiment, a default candidate can be a shortcut to indicate an EIP mode (i.e., uses the current neighbouring reconstruction samples to derive EIP models) rather than inheriting parameters from neighbours. For example, default candidate can be EIP_LT, EIP_L, EIP_T.

### II.7 Signalling the Inherited Candidate in the List

In one embodiment, an on/off flag is signalled to indicate if the current block inherits the EIP model information from neighbouring blocks or not. The flag can be signalled per CU/CB, per PU, per TU/TB, or per colour component. A high-level syntax can be signalled in SPS, PPS, PH or SH to indicate if the proposed method is allowed for the current sequence, picture, or slice.

In one embodiment, if the current block inherits the EIP model parameters from neighbouring blocks, the inherited candidate index is signalled. The index can be signalled (e.g., signalled using truncate unary code, Exp-Golomb code, or fix length code) for each colour component. For another example, the index of chroma component can be signalled and shared among Cb and Cr blocks.

### II.8 Reordering the Candidates in the List

The candidates in the list can be reordered to reduce the syntax overhead when signalling the selected candidate index. The reordering rules can depend on the coding information of neighbouring blocks or the model error. For example, if neighbouring above or left blocks are using the 4×4 square kernel, the candidates with 4×4 square kernel in the list can be moved to the beginning of the current list.

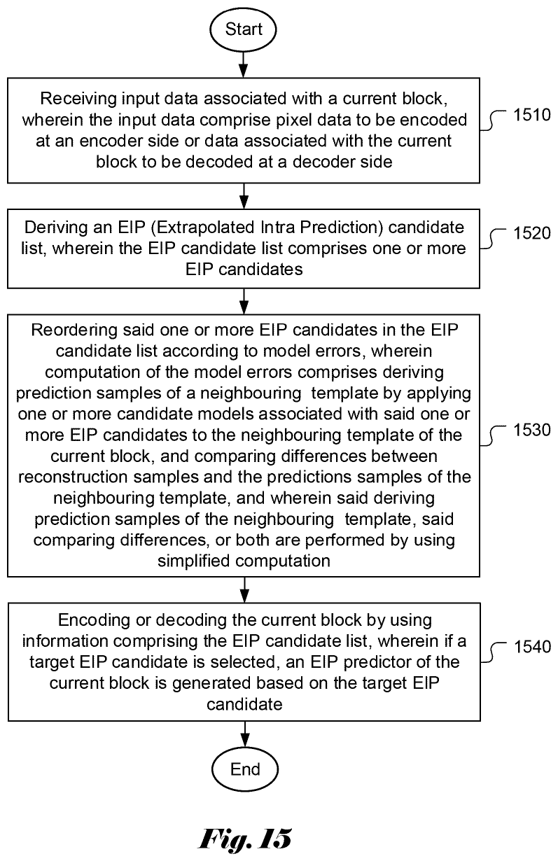

In still another embodiment, the reordering rule is based on the model error by applying the candidate model to the neighbouring templates of the current block, and then compare the error with the reconstruction samples of the neighbouring template. For example, as shown in FIG. 14, the size of above neighbouring template of the current block is wₐ×hₐ, and the size of left neighbouring template of the current block is w_{b}×h_{b}. Suppose K models are in the current candidate list. The model error of candidate k by the above neighbouring template is:

$${e}_{a}^{k} = {\sum }_{i , j} \vert {pred}_{k}^{( i , j )} - {rec}_{a}^{( i , j )} \vert$$

where,

$${pred}_{k}^{( i , j )} and {rec}_{a}^{( i , j )}$$

are the predicted value of candidate k (as described in Section “The Extrapolation Intra Prediction (EIP)”) and the reconstructed sample at position (i, j) in the above template, and 0≤i<wₐ and 0≤j<hₐ.

Similarly, the model error of candidate k by the left neighbouring template is:

$${e}_{b}^{k} = {\sum }_{m , n} \vert {pred}_{k}^{( m , n )} - {rec}_{b}^{( m , n )} \vert$$

where,

$${pred}_{k}^{( m , n )} and {rec}_{b}^{( m , n )}$$

are the predicted value of candidate k and the reconstructed sample at position (m, n) in the left template, and 0≤m<w_{b} and 0≤n<h_{b}.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the inherited candidate list by sorting the model error list in ascending order.

In still another embodiment, if the above neighbouring template is not available, then

$${e}^{k} = {e}_{b}^{k} .$$

Similarly, if the left neighbouring template is not available, then

$${e}^{k} = {e}_{a}^{k} .$$

If both templates are not available, the candidate index reordering method using model error is not applied.

In still another embodiment, not all positions inside the above and left neighbouring template are used in calculating the model error. It can choose partial positions inside the above and left neighbouring templates to calculate the model error. For example, it can define a first start position and a first subsampling interval depending on the width of the current block to partially select positions inside the above neighbouring template. Similarly, it can define a second start position and a second subsampling interval depending on the height of the current block to partially select positions inside the left neighbouring template.

In one embodiment, ha or Wp can be a constant value (e.g., ha or Wp can be 1, 2, 3, 4, 5, or 6). For another embodiment, ha or Wp can depend on block size. If the current block size is greater than or equal to a threshold, ha or Wp is equal to a first value. Otherwise, ha or Wp is equal to a second value.

In another embodiment, the model error is calculated by applying only partial selected model parameters to the neighbouring templates of the current block. Suppose a candidate model has m parameters, k out of m parameters can be chosen from the candidate model, where 0<k<m and m>1. When computing the model error, the unchosen parameters are set to 0 while the chosen parameters are kept the same. In another embodiment, when the model error is calculated only based on partial selected model parameters, an offset is added to the calculated model error to be the final model error. The calculated model error is the difference between the reconstruction samples of the neighbouring template and the prediction computed based on partial model parameters. If the calculated model error is denoted by e, the final model error, which is used in reordering, is e+Δe. For example, the offset Ae can be a fixed offset, or the mean of neighbouring templates.

In another embodiment, the model error is calculated by applying precision-reduced model parameters to the neighbouring templates of the current block. The bit-depth of the parameters can be reduced before applying the model parameters on the neighbouring templates to compute the model error. For example, a clipping operation can be used to reduce the bit depth of the integer part or the fractional part of model parameters. For another example, a rounding operation can be used to reduce the bit depth of the integer part or the fractional part of model parameters. For another example, a pruning operation can be used to reduce the bit depth. If a model parameter is smaller than a pruning threshold, this parameter will be set to zero.

In still another embodiment, the candidates of different types are reordered separately before the candidates are added into the final candidate list. For each type of the candidates, the candidates are added into a preparatory candidate list of a pre-defined size N₁. The candidates in the preparatory list are reordered. The candidates with the smallest N₂ costs are then added into the final candidate list, where N₂≤N₁. In another embodiment, the candidates are categorized into different types based on the source of the candidates, including, but not limited to, the spatial neighbouring models, temporal neighbouring models, non-adjacent spatial neighbouring models, and the historical candidates. In another embodiment, the candidates are categorized into different types based on the type of the kernel. For example, the types can be square shape, horizontal shape, vertical shape and diamond shape.

In another embodiment, only partial types of candidates are allowed to be reordered separately before the candidates are added into the final candidate list. For example, if the candidate types are categorized into spatial neighbouring models, temporal neighbouring models, non-adjacent spatial neighbouring models, and historical models, only one of the categories or more than one of categories are reordered. For another example, only the temporal and non-adjacent spatial neighbouring models are reordered separately before the candidates are added into the final candidate list.

In still another embodiment, after the candidates are reordered based on the model error (template cost), the redundancy of the candidate can be further checked. A candidate is redundant if the model error difference between it and its predecessor in the list is less than or equal to a threshold. If a candidate is redundant, it can be removed from the list, or it can be move to the end of the list.

In still another embodiment, reordering of the candidates are only performed depending on the block size or area. For example, reordering of the candidates is only performed if the size of the current encoding block is greater than or equal to a pre-defined threshold. For another example, reordering of the candidates is only performed if the width of the current encoding block is greater than or equal to a pre-defined threshold. For another example, reordering of the candidates is only performed if the height of the current encoding block is greater than or equal to a pre-defined threshold. For another example, reordering of the candidates is only performed if the size of the current encoding block is less than or equal to a pre-defined threshold. For another example, reordering of the candidates is only performed if the width of the current encoding block is less than or equal to a pre-defined threshold. For another example, reordering of the candidates is only performed if the height of the current encoding block is less than or equal to a pre-defined threshold.

In another embodiment, the candidates are categorized into multiple groups. The candidates are reordered in unit of candidate group. The groups are reordered by comparing the first candidate of each group. In one embodiment, the candidates are grouped based on the source of the candidates, including, but not limited to, the spatial neighbouring models, temporal neighbouring models, non-adjacent spatial neighbouring models, and the historical candidates. In another embodiment, the candidates are grouped based on the type of the kernel. For example, the groups can be square shape, horizontal shape, vertical shape and diamond shape. In another embodiment, the candidates are grouped based on the value of partial or all model parameters. For example, the candidates are grouped based on the c₀ of the EIP filter. Let I={I₁, I₂, I₃, . . . . I_{N}} be an interval set. For a candidate, if its first coefficient (c₀) falls in the interval Iₙ, 1≤n≤N, then the candidate is in the n-th group. The interval set I can be {[αₘᵢₙ, αₘₑₐₙ), [αₘₑₐₙ, αₘₐₓ)}, where αₘᵢₙ and αₘₐₓ are the minimum and maximum values of first coefficients (c₀) of all the candidates, and αₘₑₐₙ is the mean value of c₀ of all the candidates. For another example, the interval set I can be {[αₘᵢₙ, αₘᵢₙ+δα), [αₘᵢₙ+δα, αₘᵢₙ+2δα), [αₘᵢₙ+2δα, αₘᵢₙ+3δα), [αₘᵢₙ+3δα, αₘᵢₙ+4δα)}, where αα=(αₘₐₓ−αₘᵢₙ)/4.

In another embodiment, the number of reordering operations, i.e., the maximum allowed number of comparing operations, is constrained. Hence only partial candidates are reordered. For example, only the first few candidates in the candidate list are reordered. If the number of comparing operations is constrained to 3, only the first three candidates in the candidate list are reordered. The three comparing operations are: comparing candidate 1 and 2, comparing candidate 1 and 3 and comparing candidate 2 and 3. For another example, if the candidates are grouped into spatial/temporal/non-adjacent neighbouring models and historical models, and the candidates are reordered separately before they are added into the final candidate list. The total number of comparing operations are constrained. For example, if the total number of comparing operations is constrained to 4, only compare the 1st and 2nd candidates, and 2nd and 3rd candidates in spatial candidates, the 1st and 2nd candidates in temporal candidates, and the 1st and 2nd candidates in non-adjacent candidates.

In another embodiment, the number of model error computation operations is constrained when the reordering rule is based the model error. Only partial candidates are reordered. For example, only the first few candidates in the candidate list are reordered. If the number of model error computation operations is constrained to 3, only the model errors of the first three candidates are computed. Hence only the first 3 candidates are reordered. For another example, if the candidates are grouped into spatial/temporal/non-adjacent neighbouring models and historical models, and the candidates are reordered separately before they are added into the final candidate list. The total number of model error computation operations are constrained. For example, if the total number of model error computation operations is constrained to 4, only the model error of the first 2 spatial candidates and the model error of the first 2 temporal candidates are computed. Hence only the first 2 spatial candidates and the first 2 temporal candidates are reordered.

Any of the foregoing proposed methods of EIP candidate reordering can be applied independently or jointly. Moreover, any of the foregoing proposed methods of EIP candidate reordering can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder.

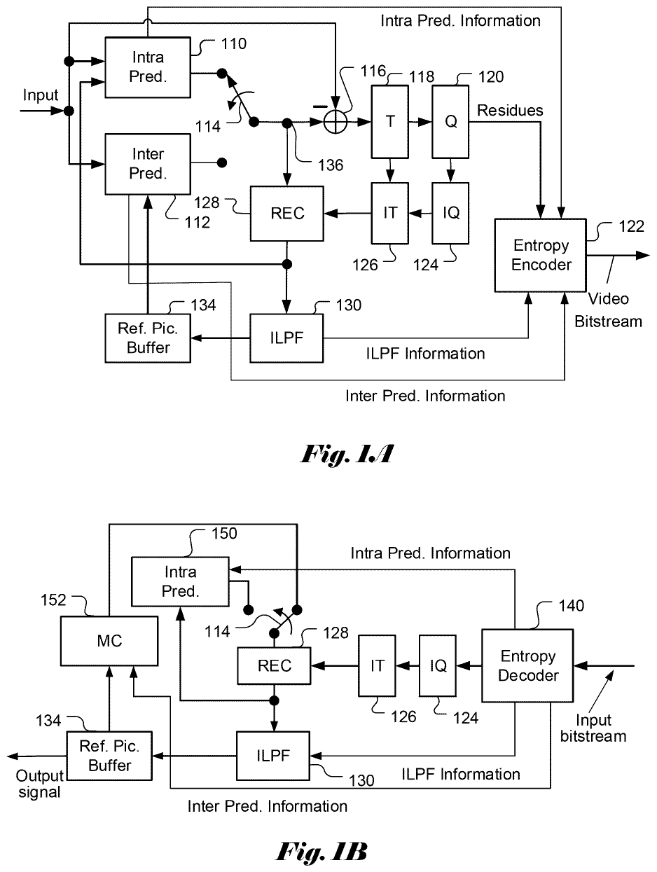

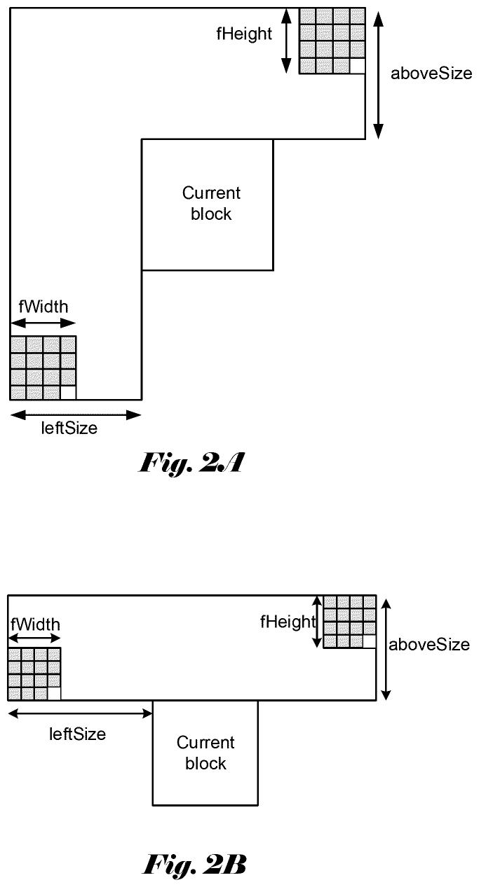

The proposed methods of EIP candidate reordering can be implemented in an encoder side or a decoder side. For example, any of the proposed methods of EIP candidate reordering can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 15 illustrates a flowchart of an exemplary video coding system that reorders EIP candidates in an EIP candidate list based on model errors associated with the EIP candidates according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block is received in step 1510, wherein the input data comprises pixel data to be encoded at an encoder side or data associated with the current block to be decoded at a decoder side. An EIP (Extrapolated Intra Prediction) candidate list is derived in step 1520, wherein the EIP candidate list comprises one or more EIP candidates. Said one or more EIP candidates in the EIP candidate list are reordered according to model errors in step 1530, wherein computation of the model errors comprises deriving prediction samples of a neighbouring template by applying one or more candidate models associated with said one or more EIP candidates to the neighbouring template of the current block, and comparing differences between reconstruction samples and the predictions samples of the neighbouring template, and wherein said deriving prediction samples of the neighbouring template, said comparing differences, or both are performed by using simplified computation. The current block is encoded or decoded by using information comprising the EIP candidate list in step 1540, wherein if a target EIP candidate is selected, an EIP predictor of the current block is generated based on the target EIP candidate.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprises pixel data to be encoded at an encoder side or data associated with the current block to be decoded at a decoder side;
deriving an EIP (Extrapolated Intra Prediction) candidate list, wherein the EIP candidate list comprises one or more EIP candidates;
reordering said one or more EIP candidates in the EIP candidate list according to model errors, wherein computation of the model errors comprises deriving prediction samples of a neighbouring template by applying one or more candidate models associated with said one or more EIP candidates to the neighbouring template of the current block, and comparing differences between reconstruction samples and the predictions samples of the neighbouring template, and wherein said deriving prediction samples of the neighbouring template, said comparing differences, or both are performed by using simplified computation; and
encoding or decoding the current block by using information comprising the EIP candidate list, wherein if a target EIP candidate is selected, an EIP predictor of the current block is generated based on the target EIP candidate.

2. The method of claim 1, wherein the model errors are calculated by using partial positions inside the neighbouring template.

3. The method of claim 2, wherein the partial positions correspond to subsampled positions of the neighbouring template.

4. The method of claim 3, wherein the neighbouring template comprises an above neighbouring temple on an above side of the current block, and a start position and a subsampling interval of the subsampled positions of the above neighbouring template depend on width of the current block.

5. The method of claim 3, wherein the neighbouring template comprises a left neighbouring temple on a left side of the current block, and a start position and a subsampling interval of the subsampled positions of the left neighbouring template depend on height of the current block.

6. The method of claim 2, wherein the model errors are calculated by using an above neighbouring temple on an above side of the current block, and height of the above neighbouring template corresponds to a constant or depends on current block size.

7. The method of claim 2, wherein the model errors are calculated by using a left neighbouring temple on a left side of the current block, and width of the left neighbouring template corresponds to a constant or depends on current block size.

8. The method of claim 1, wherein the model errors are calculated by applying partial model parameters of said one or more EIP candidates to the neighbouring template of the current block respectively.

9. The method of claim 8, wherein unchosen parameters of model parameters are set to 0 while chosen parameters of the partial model parameters are kept the same.

10. The method of claim 1, wherein the model errors are calculated by applying precision-reduced model parameters of said one or more EIP candidates to the neighbouring template of the current block respectively.

11. The method of claim 10, wherein bit-depth of model parameters of said one or more EIP candidates are reduced before said applying the precision-reduced model parameters of said one or more EIP candidates to the neighbouring template of the current block respectively.

12. The method of claim 11, wherein the bit-depth of model parameters of said one or more EIP candidates are reduced using clipping operations, pruning operation, or rounding operation.

13. The method of claim 12, wherein if a target model parameter is smaller than a pruning threshold, the target model parameter is set to zero.

14. An apparatus for video coding, the apparatus comprising one or more electronic circuits or processors arranged to:
receive input data associated with a current block, wherein the input data comprises pixel data to be encoded at an encoder side or data associated with the current block to be decoded at a decoder side;
derive an EIP (Extrapolated Intra Prediction) candidate list, wherein the EIP candidate list comprises one or more EIP candidates;
reorder said one or more EIP candidates in the EIP candidate list according to model errors, wherein computation of the model errors comprises deriving prediction samples of a neighbouring template by applying one or more candidate models associated with said one or more EIP candidates to the neighbouring template of the current block, and comparing differences between reconstruction samples and the predictions samples of the neighbouring template, and wherein said deriving prediction samples of the neighbouring template, said comparing differences, or both are performed by using simplified computation; and
encode or decode the current block by using information comprising the EIP candidate list, wherein if a target EIP candidate is selected, an EIP predictor of the current block is generated based on the target EIP candidate.
